(19) United States
(12) Patent Application Publication
(10) Pub. No.: US 2012/0274950 A1
(43) Pub. Date: Nov. 1, 2012

(54) IMAGE PROCESSING APPARATUS, IMAGE PROCESSING METHOD, AND COMPUTER-READABLE MEDIUM

(75) Inventor: Atsushi Shoji, Kawasaki-shi (JP)

(73) Assignee: CANON KABUSHIKI KAISHA, Tokyo (JP)

(21) Appl. No.: 13/442,233

(22) Filed: Apr. 9, 2012

(30) Foreign Application Priority Data
Apr. 28, 2011 (JP) 2011-102345

(51) Int. Cl. G06K 15/02

(52) U.S. Cl. 358/1.2

(57) ABSTRACT

An image processing apparatus comprises a reception unit configured to receive data with a first resolution, a correction unit configured to correct a coordinate system of the data with the first resolution into a coordinate system with a second resolution higher than the first resolution, a rendering unit configured to perform rendering processing for the data with the second resolution which is corrected to the coordinate system with the second resolution by the correction unit, and a resolution conversion unit configured to convert the data with the second resolution rendered by the rendering unit into the data with the first resolution by performing weighting calculation processing for a pixel in the data with the second resolution and a neighbor pixel of the pixel.

### BACKGROUND OF THE INVENTION

1. Field of the Invention

The present invention relates to an image processing apparatus which performs rendering processing at a resolution higher than the printing resolution of a printing mechanism, converts a rendering image into multilevel data with the actual printing resolution of the printing mechanism, and performs printout, an image processing method, and a computer-readable medium.

2. Description of the Related Art

An electrophotographic printing apparatus develops the latent image, generated on a photosensitive member by optical rendering, with toner, and transfers the developed toner image onto a sheet. The printing apparatus then performs printout upon fixing the toner image on the sheet with heat and pressure. As optical rendering performed in this case, the apparatus uses optical scanning rendering using a semiconductor laser or optical rendering using an LED array or the like. The resolution of a rendered image is determined by optical rendering. For example, if the scanning density of an optical laser is 1,200 dpi, the printing resolution becomes 1,200 dpi. If the LED spacing of an LED array corresponds to 600 dpi, the printing resolution becomes 600 dpi.

In this case, since a printing resolution greatly influences the cost of a mechanical portion, it is difficult to provide a high-resolution printing apparatus with a low-price mechanical portion. It is however desirable even for a low-price printing mechanism to provide images with as high image quality as possible.

In optical rendering performed by an electrophotographic printing apparatus, a generated optical latent image has a potential distribution with a slope, which can be approximated by a Gaussian distribution. A plurality of adjacent Gaussian distributions are combined into one Gaussian distribution. Therefore, a plurality of adjacent optical renderings become one composite latent image. Using this phenomenon can generate an optical latent image at an intermediate position in a rendering coordinate system in physical optical scanning. Since a rendering phase is finer than the phase implemented by a physical printing resolution, it looks as if rendering were executed at a resolution higher than the optical scanning resolution. There is known a technique of rendering image information with a resolution higher than the printing resolution in advance and generating, in the processing of conversion to a low printing mechanism resolution, high-resolution data in a pseudo manner by performing conversion to generate such an intermediate coordinate rendering (see Japanese Patent Laid-Open No. 2005-143045). These techniques can provide a printout with a resolution higher than the actual printing resolution of a printing mechanism. Increasing the rendering resolution can express a character object with many pixels or lines varying in strength in a well balanced manner. This improves the evenness of consecutive thin line patterns. This also improves the quality of halftoning for the expression of halftone densities.

In the above processing system, an image forming unit which renders a print image simply regards the printing apparatus as a high-resolution printer and executes high-resolution rendering. However, an actual printing mechanism is sometimes a printing apparatus with a resolution lower than that of a rendering image. In this case, a problem arises when an object to be rendered has a fine structure with dimensions on the order of the resolution of the printing apparatus. More specifically, a problem sometimes arises when rendering fine characters, continuous thin lines, and the like.

For example, let k be the ratio between the resolution of rendering data and that of the printing mechanism. When rendering an object, k phase patterns of 0, 1/k, . . . , (k−1)/k are generated. Consider specific numerical values in this case. When k=2, two phase patterns of 0 and 1/2 are generated. When k =3, three phase patterns of 0, 1/3, and 2/3 are generated.

FIGS. 1A and 1B show the results obtained by rendering character objects with different phases and converting the resultant data into printing-resolution multilevel data when k=2 in both the X and Y directions. The images shown in FIG. 1A are bitmap images of high-resolution rendering data. In the lattice images shown in FIG. 1A, the thin frames correspond to a coordinate system having undergone high-resolution rendering, and thick frames correspond to a coordinate system with the printing resolution. That is, when k=2, a high-resolution rendering coordinate system has a resolution twice the printing-resolution coordinate system.

In this example of rendering, rendering is performed for the right and left characters in FIG. 1A in both the X and Y directions with different pixel phases in the correspondence relationship between the printing resolution and the rendering resolution. FIG. 1B shows the images obtained by converting the identical objects with different phases into printing-resolution multilevel data. Converting rendering data with different phases into printing-resolution multilevel data will output different outputs even in the case of identical objects, as shown in FIG. 1B.

In a printing apparatus using a mechanism that converts high-resolution rendering data into low-resolution multilevel data, the printing mechanism is adjusted to obtain similar printouts from these different multilevel data. However, printing apparatuses have individual differences, and changes in characteristic due to environmental fluctuations and variations in characteristics of consumable items up to their service lives. When actually printing out different multilevel data, it is difficult to perform adjustment so as to always obtain similar printouts.

### SUMMARY OF THE INVENTION

According to one aspect of the present invention, there is provided an image processing apparatus comprising: a reception unit configured to receive data with a first resolution; a correction unit configured to correct a coordinate system of the data with the first resolution into a coordinate system with a second resolution higher than the first resolution; a rendering unit configured to perform rendering processing for the data with the second resolution which is corrected to the coordinate system with the second resolution by the correction unit; and a resolution conversion unit configured to convert the data with the second resolution rendered by the rendering unit into the data with the first resolution by performing weighting calculation processing for a pixel in the data with the second resolution and a neighbor pixel of the pixel.

The present invention can eliminate variations in rendering images of identical objects such as fine characters and improve print quality.

Further features of the present invention will become apparent from the following description of exemplary embodiments (with reference to the attached drawings).

### BRIEF DESCRIPTION OF THE DRAWINGS

FIGS. 1A and 1B are views for explaining the problems in the prior art;

FIG. 2 is a view showing the main part of a laser scanning type electrophotographic printing mechanism;

FIGS. 3A and 3B are views showing the correspondence between an actual image and image data in a printing-resolution coordinate system;

FIGS. 4A, 4B, and 4C are views showing the correspondence between a high-resolution rendering coordinate system and a printing-resolution coordinate system when k=2;

FIGS. 5A and 5B are views showing an example of conversion to actual-resolution multilevel data by object rendering;

FIG. 6 is a flowchart showing a procedure for rendering processing by a printing mechanical unit;

FIG. 7 is a flowchart showing a procedure for object coordinate correction processing according to the first embodiment;

FIGS. 8A, 8B, and 8C are views for explaining rendering processing results according to the first embodiment;

FIG. 9 is a block diagram showing the arrangement of an image forming unit according to the second embodiment;

FIG. 10 is a flowchart showing a procedure for object coordinate correction processing according to the second embodiment;

FIGS. 11A and 11B are views showing how rendering positions are corrected based on correction amount vectors; and

FIG. 12 is a conceptual view of image data obtained by image processing.

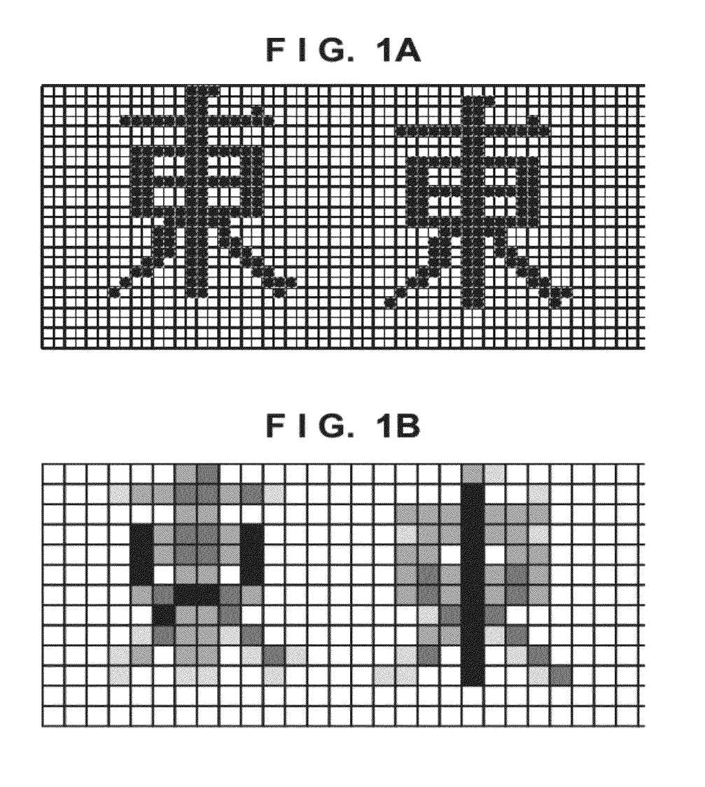

### DESCRIPTION OF THE EMBODIMENTS

The best mode for carrying out the present invention will be described in detail below with reference to the accompanying drawings. Note that an image processing apparatus according to this embodiment is, for example, a printing apparatus having a printing mechanism or a multifunction peripheral (MFP).

### First Embodiment

### [System Arrangement]

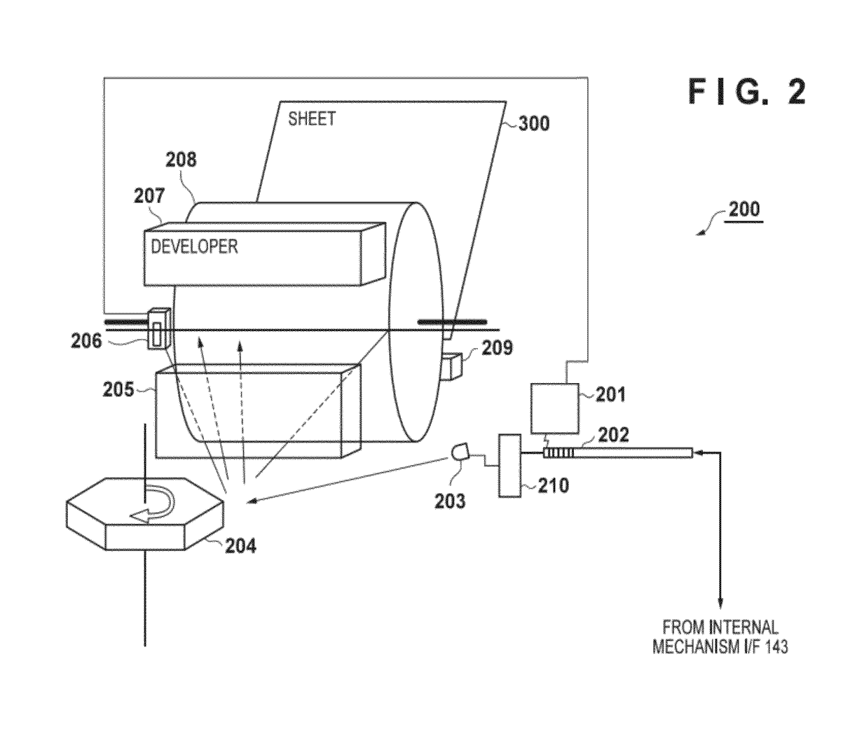

The first embodiment of the present invention will be described below. FIG. 2 shows the main part of a laser scanning type electrophotographic printing mechanism according to this embodiment. This printing mechanism is mounted in an image processing apparatus to which the present invention can be applied. A mechanical unit 200 as this printing mechanism includes a clock generation circuit 201. The data held in a line buffer 202 is output to a modulation circuit 210 in synchronism with the clocks generated by the clock generation circuit 201. The line buffer 202 stores data corresponding to one line of an image received from an internal mechanism I/F 143. The line buffer 202 is driven by clocks from the clock generation circuit 201 in response to the timing of optical scanning to transmit data to the modulation circuit 210.

The modulation circuit 210 drives a laser upon converting density information into a light amount. A laser diode 203 emits light to render an optical latent image on a photosensitive member 208. A polygon mirror 204 reflects light from the laser diode 203 while rotating to implement scanning by the fixed light source (laser diode 203). Since the light reflected by the rotating polygon mirror 204 is not scanned at a constant speed, an optical system 205 converts an optical path so as to scan the light on the photosensitive member 208 at a constant speed. A synchronization circuit 206 is a synchronization detection sensor. The polygon mirror 204 is not an ideal polygon due to the limit of machining accuracy, with each surface deviating from a corresponding surface of a regular polygon. For this reason, the optical scanning start times on the respective surfaces of the polygon mirror 204 vary, and hence do not occur at the same timing. The synchronization circuit 206 therefore detects the timing of optical rendering on the photosensitive member 208, and the clock generation circuit 201 operates in phase with the synchronization circuit 206. In addition, driving the line buffer 202 by using synchronized clocks will align, on the photosensitive member 208 in the scanning direction, image data corresponding to one scan on the line buffer 202.

A developer 207 forms a toner image by making charged toner adhere on an optical latent image on the photosensitive member 208. The photosensitive member 208 develops the optical latent image with toner after the optical latent image is rendered on the photosensitive member, and transfers the image onto a sheet. A transfer mechanism 209 transfers the toner image on the photosensitive member 208 onto a sheet 300.

The sheet 300 is conveyed inside the apparatus at the time of printing operation. The transfer mechanism 209 transfers the toner image formed on the photosensitive member 208 onto the sheet 300. The sheet 300 on which the toner image is transferred is moved to a fixing mechanism (not shown), at which the toner image is fixed and printed out.

[Correspondence Between Actual Image and Image Data]

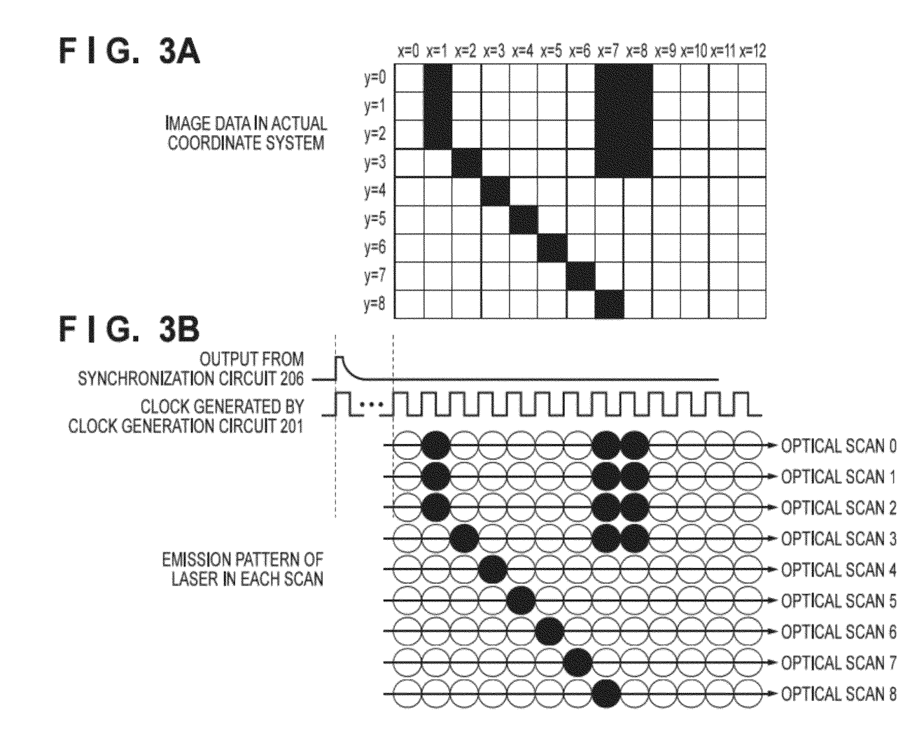

FIGS. 3A and 3B are views showing the correspondence between the actual image rendered by the printing mechanism shown in FIG. 2 and the image data in the printing-resolution coordinate system. Referring to FIGS. 3A and 3B, the main scanning direction and the sub-scanning direction in the coordinate system of the image data are respectively represented by x and y. For the sake of convenience, the coordinate system with a resolution set when the printing apparatus (printing mechanism) in this embodiment outputs is written as “actual coordinate system”. In addition, the coordinate system with the high resolution designated by rendering data is written as “high-resolution rendering coordinate system”.

The laser beam scanned on the photosensitive member 208 at a constant speed is demarcated at equal widths by the clocks generated by the clock generation circuit 201 as indicated by the laser emission pattern shown in FIG. 3B. In this case, column data with y=0 shown in FIG. 3A is received from the internal mechanism I/F 143 and stored in the line buffer 202.

The clock generation circuit 201 operates in response to a sync signal for optical scan 0, and sends one-pixel data to the modulation circuit 210 of the light source (laser diode 203) for each clock. The apparatus turns on and off the laser beam emitted by the laser diode 203 for each clock in accordance with a signal from the modulation circuit 210, thereby performing optical rendering based on an image data pattern. The mechanical unit 200 repeats this rendering operation with respect to each scanning line. In optical scan 1, the apparatus stores column data with y=1 in the line buffer 202, and then sends out the data in synchronism with a clock. In optical scan 2, the apparatus sends out column data with y=2 in the same manner, and sequentially drives the laser beam. Finally, the apparatus generates a two-dimensional latent image on the photosensitive member 208.

When performing multilevel driving for each pixel, the apparatus causes the modulation circuit 210 to convert multilevel data into a light amount, and drives the laser diode 203 as a light source. In this case, a semiconductor laser unit like the laser diode 203 changes its characteristics due to self-heating. This makes it difficult to perform stable modulation based on light intensity. In light intensity modulation using a laser beam, the apparatus generally controls the light intensity constant and adjusts the light amount by controlling the emission time. For control on the emission time, the apparatus uses PWM (Pulse Width Modulation), PNM (Pulse Number Modulation), or the like.

A printing apparatus configured to improve print quality by high-resolution rendering, to which the present invention is applied, uses image data with a resolution higher than the printing resolution. In this case, the high-resolution rendering coordinate system corresponds to the actual coordinate system of the printing mechanism at a predetermined ratio.

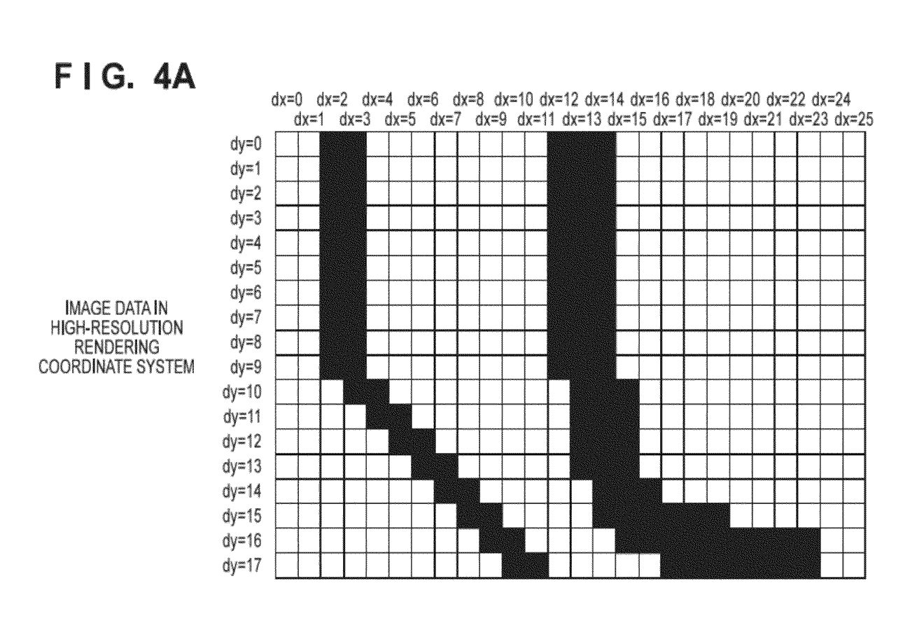

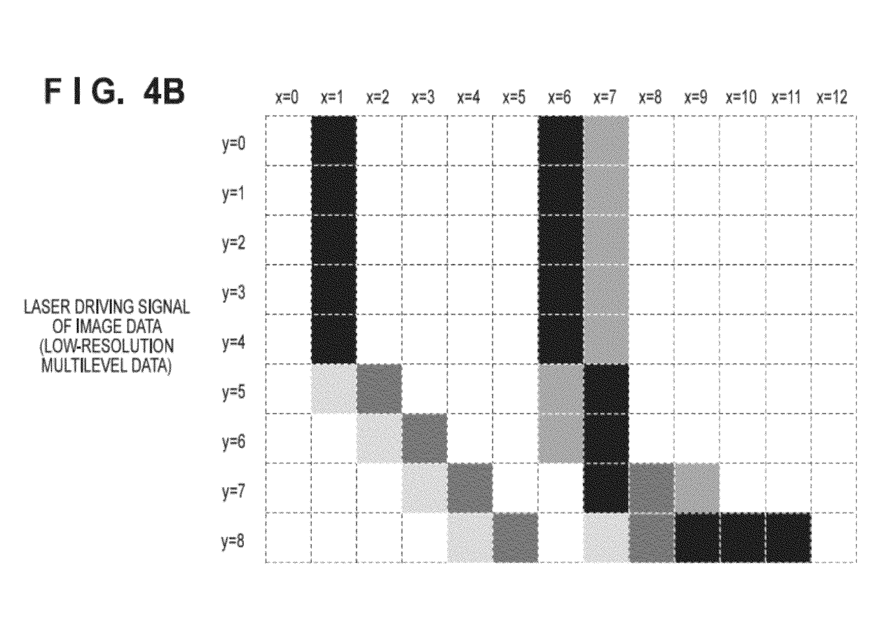

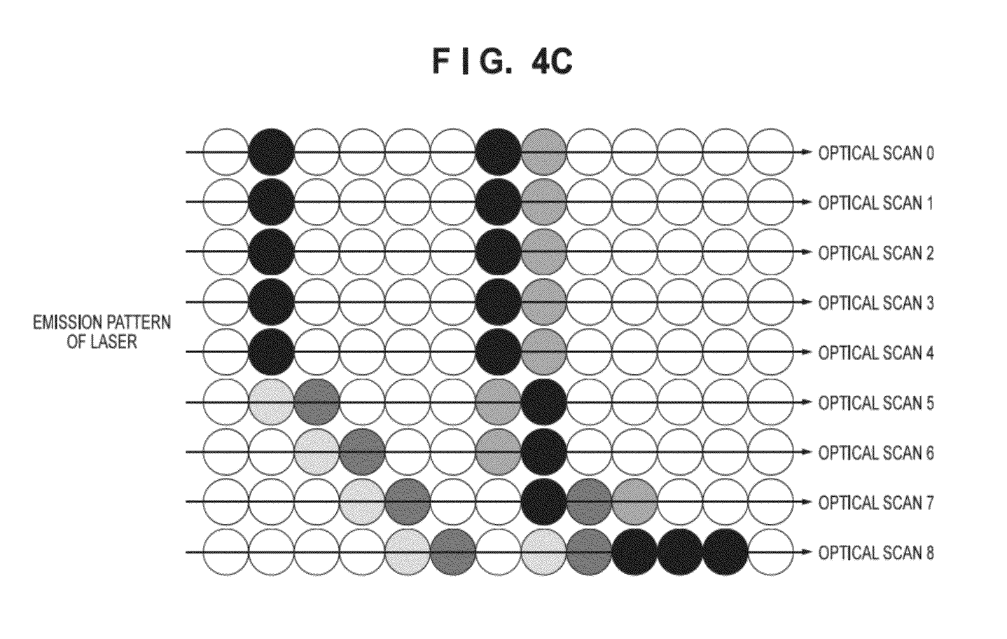

As shown in FIG. 4A, the high-resolution coordinate system allows to generate image data with a higher resolution than the actual coordinate system. The image processing apparatus converts image data into multilevel data in the actual coordinate system of the printing mechanism like that shown in FIG. 4B, and stores the data in the line buffer 202 for each optical scan in the emission pattern shown in FIG. 4C. FIGS. 4A to 4C show an example with k=2 as described above. In this case, the variable k indicates the relationship between the high-resolution rendering coordinate system in high-resolution rendering and the actual coordinate system of the printing mechanism. That is, when k=2, the high-resolution rendering resolution is twice the resolution of the printing mechanism. This embodiment will exemplify a case with k=2.

The laser renders with different light intensities for the respective pixels based on multilevel data to form a latent image on the photosensitive member 208. As shown in FIGS. 3A and 3B and FIGS. 4A to 4C, when a virtual high-resolution rendering coordinate system (dx, dy) has a relationship of k=2 with an actual coordinate system (x, y) of the printing mechanism, mutual coordinate conversion can be performed with x=dx/2 and y=dy/2.

Assume that when high-resolution data is to be converted into low-resolution data, simple thinning processing is performed. In this case, only information corresponding to 1/(k×k) of the original image is left, and the information of other pixels is lost. In general, therefore, the loss of information is reduced by generating one piece of pixel information by referring to a plurality of pieces of pixel information.

In resolution conversion, a technique of weighting original pixels is an important technique when generating one piece of pixel information from a plurality of pixels. This embodiment will exemplify the use of a most simple equal average value. That is, an equal average value with k=2 is obtained as follows:

D(a, b)=(P(2a, 2b)+P(2a, 2b+1)+P(2a+1, 2b)+P(2a+1, 2b+1)/4

where D is the density of the pixels in the actual coordinate system, and P is the density of the pixels in the high-resolution rendering coordinate system.

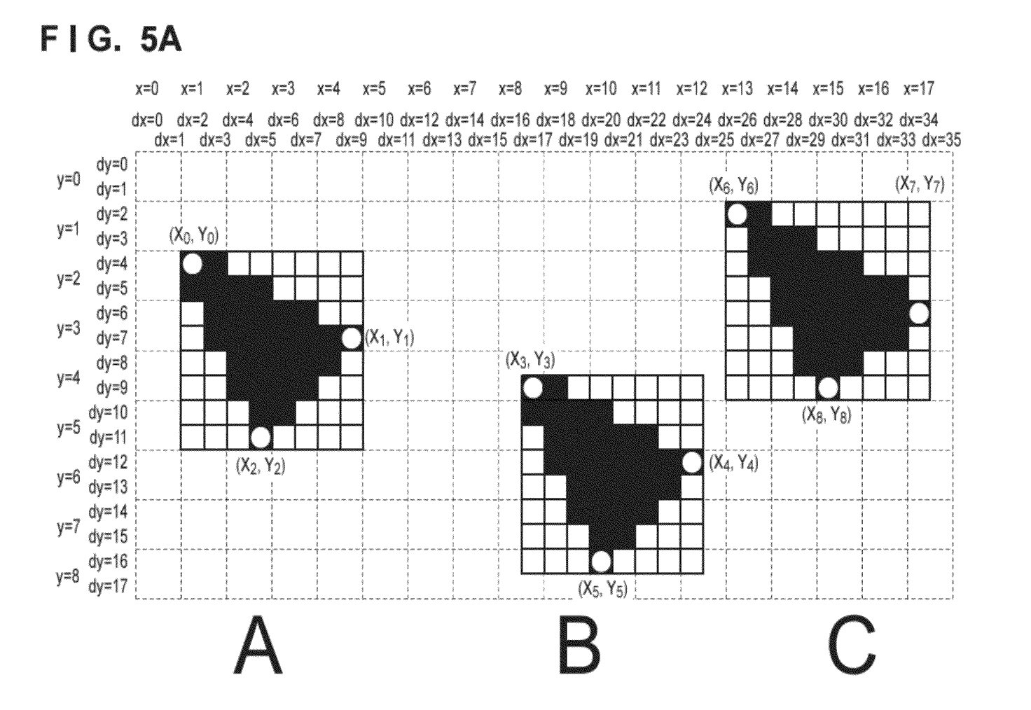

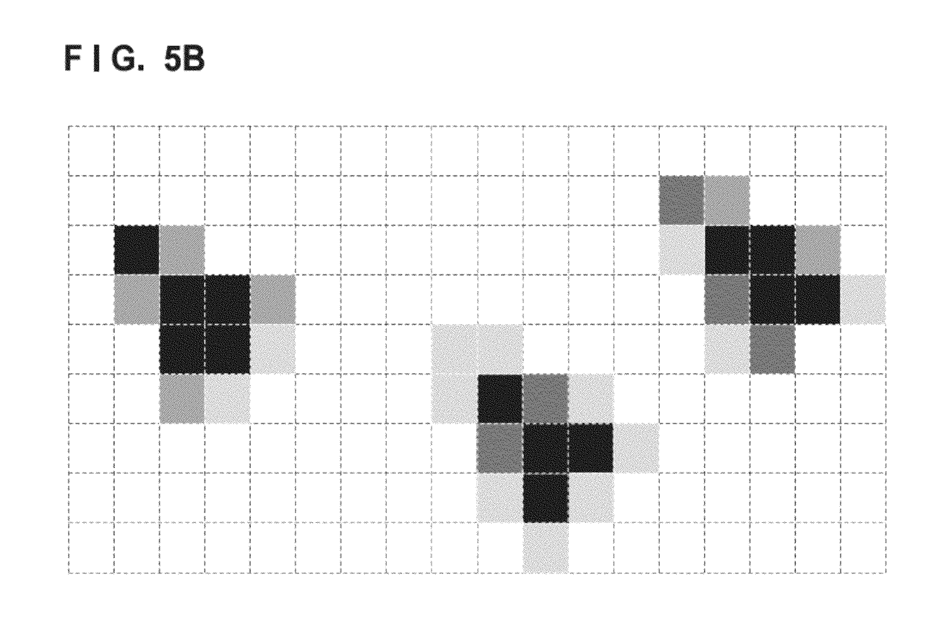

FIGS. 5A and 5B show a case in which the apparatus renders triangles, which are most simple objects, and converts them into multilevel data in the actual coordinate system. Referring to FIG. 5A, the same object as a triangle A indicated by (X0, Y0) to (X2, Y2) is rendered as a triangle B at (X3, Y3) to (X5, Y5). In this case, as shown in FIG. 5B, when performing conversion to actual resolutions, the apparatus converts the objects into different multilevel images with actual resolutions in the printing mechanism if the pixels of the respective objects differ in phase. That is, the apparatus renders the triangles A and B into different images in spite of the fact that they are the identical objects.

Referring to FIG. 5A, a triangle C is an example of the image obtained by performing correction so as to match the triangle A with the resolution and phase of the printing mechanism. As indicated by the triangle C, when performing rendering all the vertex coordinates at (X6, Y6) to (X8, Y8) upon matching with the resolution and phase of the printing mechanism, the distances between the respective points (the relative relationship between the pixels within the object) change, resulting in the collapse of the shape. As a result, the image output from the printing mechanism differs from the image intended by the user.

The present invention therefore controls a phase pattern for only the start coordinates corresponding to a reference pixel of the pixels included in the an object. That is, the apparatus corrects coordinates so as to make only the start coordinates of an object always have a predetermined phase pattern relative to the actual coordinate system of the printing mechanism. The present invention features that coordinates are corrected so as not to impair the relative relationship between the start coordinates and the coordinates other than the reference pixel.

In the case shown in FIG. 5A, the apparatus corrects the phase pattern of the coordinates (X0, Y0) of the triangle A of the respective triangular objects, and avoids to impair the relative relationship between the coordinates of the remaining pixels in the triangle.

[Processing Procedure]

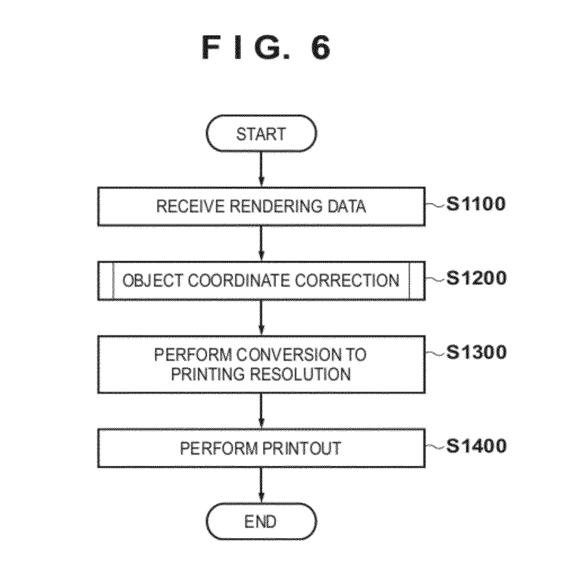

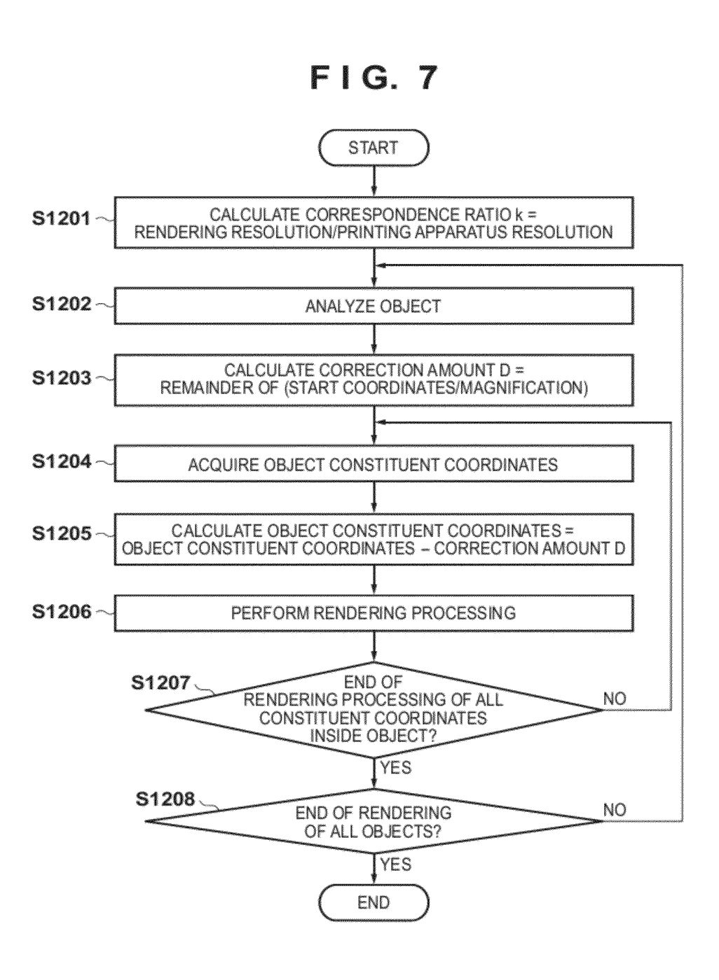

FIGS. 6 and 7 show procedures for correction processing and rendering processing for object coordinates according to this embodiment. FIG. 6 schematically shows a procedure for the overall operation of the printing apparatus. FIG. 7 shows a procedure for correction processing for the coordinate system of a rendering object. Assume that a control unit (not shown) executes the processing shown in FIGS. 6 and 7.

Referring to FIG. 6, when starting the processing, the control unit externally receives data (S1100). Assume that the received data is high-resolution data (data with a resolution higher than that in the printing mechanism). The control unit executes coordinate correction processing of the rendering object relative to the acquired objects (S1200). This processing will be described in detail with reference to FIG. 7. The control unit converts the data having undergone the coordinate correction processing of the rendering object in step S1200 into printing-resolution multilevel data (S1300). The control unit executes printout based on the converted printing-resolution data (S1400).

In this embodiment, a rendering mechanism for high-resolution data has a function of painting the closed region designated by coordinates. With this function, the printing apparatus can covert received data, divide a rendering element (object), and reduce the divided elements into a closed region. Reducing all the rendering elements included in received data allows to uniformly process information about all objects.

FIG. 7 shows a detailed procedure for coordinate correction processing of the rendering object in step S1200 shown in FIG. 6. When starting this processing, the control unit calculates the correspondence ratio (magnification k) between the rendering resolution of rendering data and the resolution of the printing mechanism (S1201). The correspondence ratio calculated in step S1201 corresponds to the ratio between the resolutions before and after resolution conversion performed in step S1300. The control unit analyzes objects in rendering data to extract identical objects (S1202). Assume that in this case, as an extraction method, the apparatus uses a conventional technique. However, the technique to be used is not specifically limited. Note that in step S1202, the control unit may extract, for example, an object having a specific attribute (for example, a character). The control unit selects one of the extracted objects. The control unit calculates the remainder of the start coordinates by using the correspondence ratio calculated in step S1201 to calculate a correction amount vector D (S1203). The start coordinates in this case are the coordinates of a pixel, of the pixels included in the object extracted in step S1202, which is located near the origin. In this embodiment, the control unit calculates the correction amount vector D according to the following equation:

correction amount vector D=remainder of (start coordinates (X, Y)/magnification k)

Note that the start coordinates in this case are those in the high-resolution rendering coordinate system.

The control unit then acquires object constituent coordinate information corresponding to the selected object (S1204). The control unit calculates corrected coordinates by applying the correction amount vector D calculated in step S1203 to the acquired object constituent coordinate information (S1205). In this embodiment, the control unit calculates corrected coordinates according to the following equation:

corrected coordinates=object constituent coordinates (X, Y)−correction amount vector D

Assume that the object constituent coordinates in this case are those in the high-resolution rendering coordinate system.

The control unit executes rendering processing of the object at the corrected coordinates calculated in step S1205 (S1206). The control unit repeats rendering processing for all pieces of coordinate information constituting an object (S1207). Upon terminating the processing for one object (YES in step S1207), the control unit selects a new object, and repeats the processing in steps S1203 to S1207 (S1208).

With the above processing in this embodiment, the control unit executes coordinate correction of the same correction amount vector D with respect to all the coordinates constituting one object. This corrects the rendering positions of the coordinates of the pixels constituting the object, but makes no change in relative coordinates between the pixels in the object.

[Processing Results]

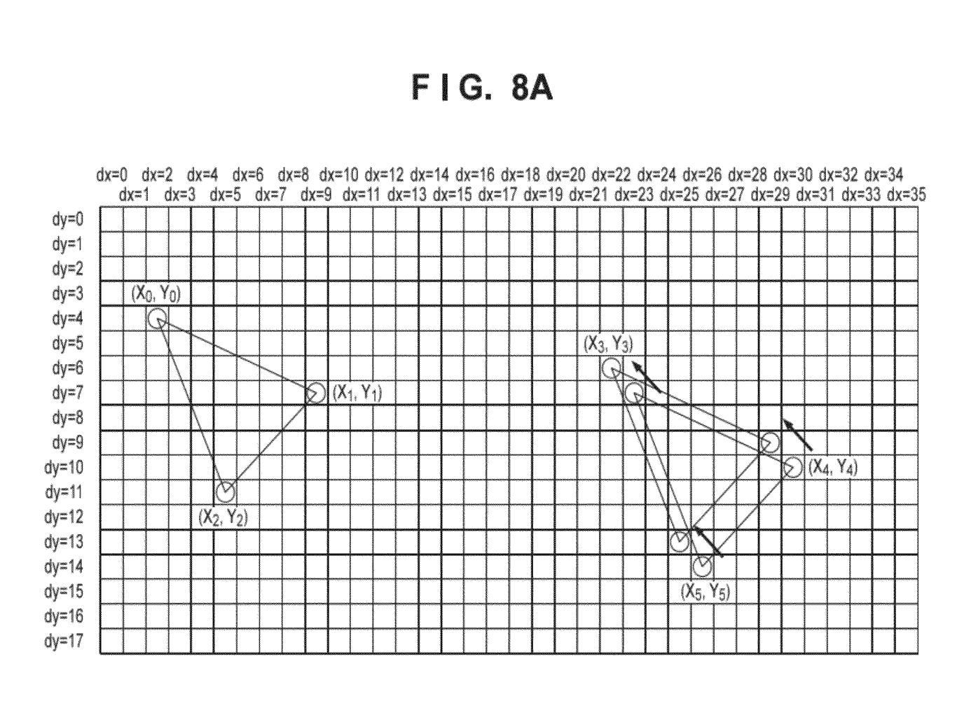

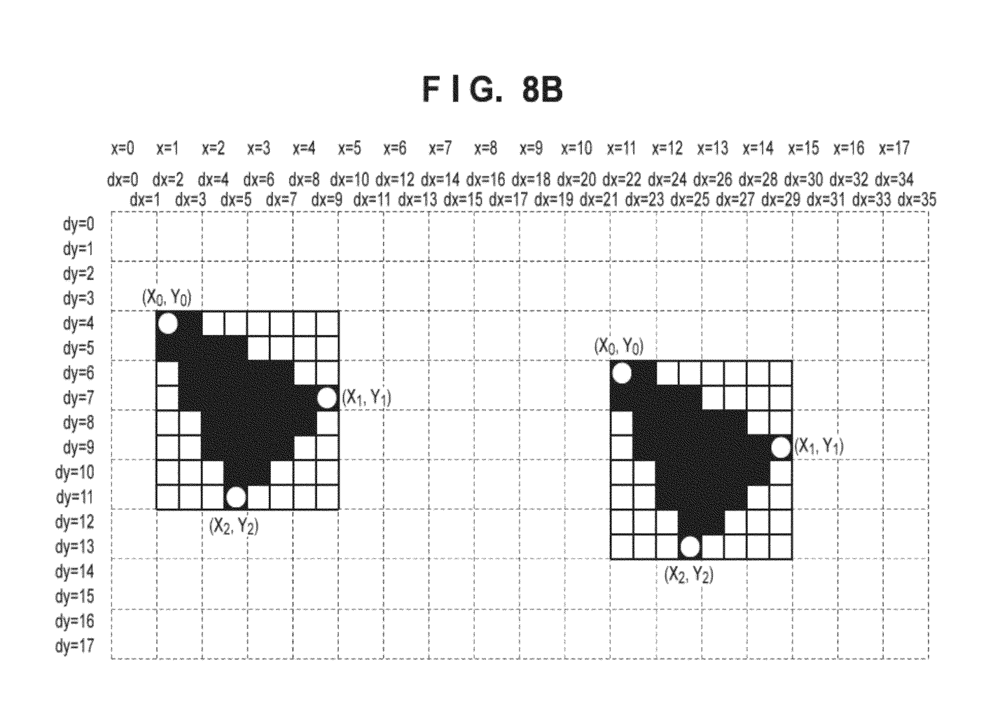

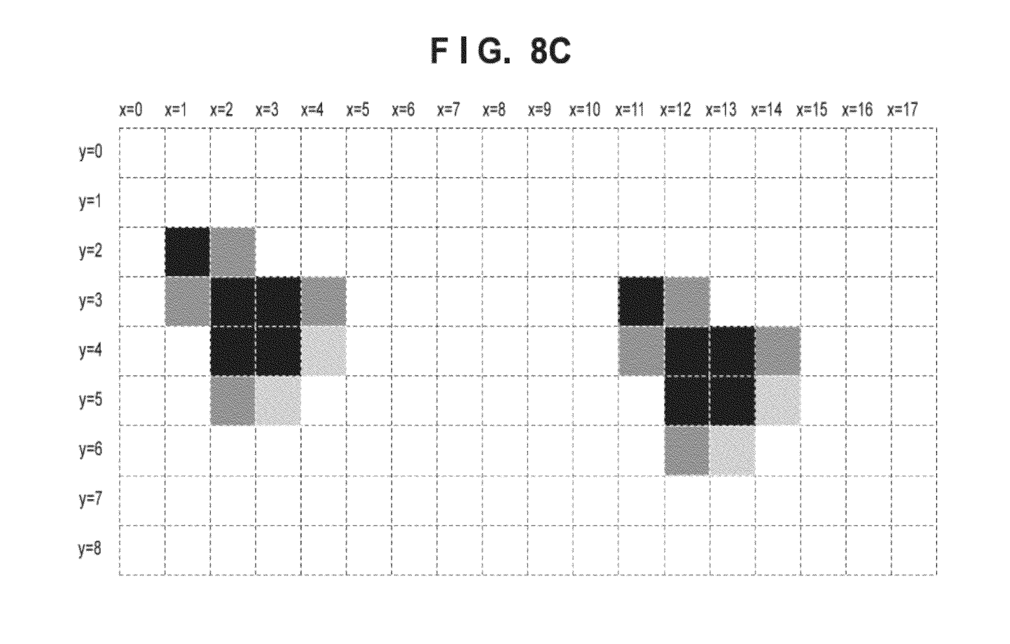

FIGS. 8A to 8C show the processing results respectively obtained when correction amount vector D=(0, 0) and when correction amount vector D=(1, 1).

Referring to FIG. 8A, the start coordinates of an object, (X0, Y0) to (X2, Y2) as a reference object are (X0, Y0)=(2, 4) in the high-resolution rendering coordinate system (dx, dy). In the actual coordinate system (x, y) of the printing mechanism, these coordinates are (1, 2). That is, remainder vector (correction amount vector D) of k=2 is (0, 0).

The start coordinates of an object, (X3, Y3) to (X5, Y5) are (X3, Y3)=(23, 7) in the high-resolution rendering coordinate system (dx, dy). In the actual coordinate system (x, y) of the printing mechanism, these coordinates are (11, 3). That is, the remainder of k=2 is (1, 1).

Since the remainder vector of the object, (X0, Y0) to (X2, Y2) is D=(0, 0), the printing correction amount is “0”. Therefore, the coordinates of the object, (X0, Y0) to (X2, Y2) are not changed. In contrast to this, the remainder vector of the object, (X3, Y3) to (X5, Y5) is D=(1, 1). Therefore, the value of the coordinates (X3, Y3) after printing correction with respect to the high-resolution rendering coordinate system (dx, dy) is changed from (23, 7) to (22, 6) relative to the object, (X3, Y3) to (X5, Y5). Likewise, the value of the coordinates (X4, Y4) is changed from (30, 10) to (29, 9), and the value of the coordinates (X5, Y5) is changed from (26, 14) to (25, 13).

Referring to FIGS. 8B and 8C, the actual-resolution multilevel data of the object, (X0, Y0) to (X2, Y2) starts from (1, 2) in the actual coordinate system (x, y). The actual-resolution multilevel data of the object, (X3, Y3) to (X5, Y5) starts from (11, 3) in the actual coordinate system (x, y). Obviously, when D=(1, 1), although the rendering position of the object is slightly corrected, the data obtained by multilevel conversion to the printing resolution represents the same object as that without correction.

Note that in this embodiment, the apparatus calculates the correction amount vector D so as to approach an origin (x=0, y=0) when applying the correction amount vector D to coordinates constituting an object. However, the present invention is not limited to this. The correction amount vector D may be applied to the coordinates so as to match phase patterns in consideration of the value of k and the like. For example, the correction amount vector D may be applied to the coordinates so as to separate from the origin.

In addition, this embodiment regards, as the start coordinates, one of the pixels included in an object which is located nearest to the origin. However, the present invention is not limited to this. For example, it is possible to set, as the start coordinates, the coordinates of a pixel located at the farthest position from the origin.

With the above processing, matching the phases of identical objects such as fine characters can eliminate variations in image, thus improving the print quality.

### Second Embodiment

The second embodiment for executing the present invention will be described below. In the second embodiment, an image processing apparatus receives low-resolution (a first resolution lower than a second resolution) data from an application on the host computer side instead of data with a resolution corresponding to the high-resolution (second resolution) rendering coordinate system.

In this embodiment, in order to perform rendering at a high resolution, the image processing apparatus needs to calculate data in the high-resolution rendering coordinate system from received data with a first resolution. For high-resolution rendering, the apparatus converts data in a first-resolution coordinate system (x, y) into data in a high-resolution rendering coordinate system (dx, dy) by using the following equations. Note that the first resolution is equal to the resolution of the printing mechanism of the image processing apparatus.

dx =x×k

dy=y×k

Since coordinates always keep a predetermined phase with k times actual coordinates of the printing mechanism, there is no need to correct rendering coordinates. Rendering the start coordinates of a general object at a high resolution will not change the coordinate resolution of an image in the actual coordinate system. However, since the density interface of the object is converted into multilevel data, it is hard to distinguish pixel steps when the image is printed. That is, the print quality of contours improves.

In addition, when processing a character object, the apparatus may receive only start coordinates as externally provided coordinate information. The apparatus needs to search dictionary data defining character information from the character type and character code received as attribute information and scale the remaining coordinate information to the size designated by the font size. Note that a general processing system scales coordinate values so as to properly print an image with a designated font size at the printing resolution of the printing mechanism.

In this embodiment, the apparatus scales coordinate values so as to make an image with a designated font size have a proper size in the high-resolution rendering coordinate system. Since start coordinates are generated by converting coordinates in the actual coordinate system, the phase matches that of an actual image. However, the relative distances between the strokes constituting a character object are scaled to those in the high-resolution rendering coordinate system to generate a high-resolution character object.

[Arrangement of Image Forming Unit]

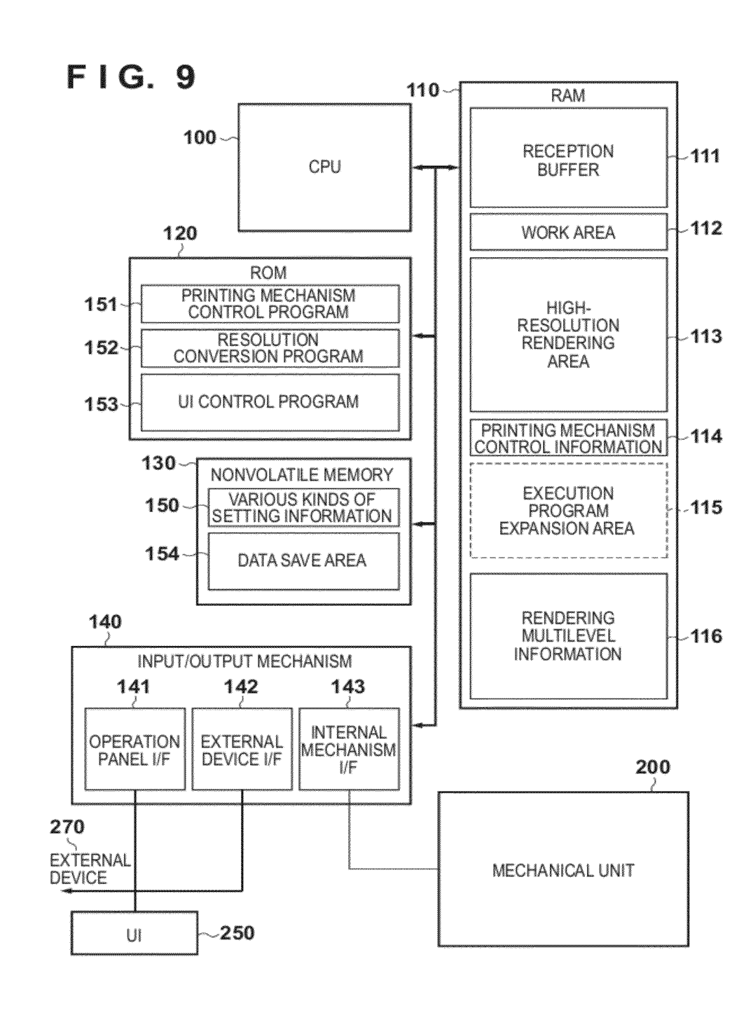

FIG. 9 shows the arrangement of the image forming unit of the image processing apparatus according to the second embodiment. The image forming unit includes a CPU 100, a RAM 110, a ROM 120, a nonvolatile memory 130, and an input/output mechanism 140.

The CPU 100 executes control on a control program for starting the printing mechanism by a necessary procedure and on a user interface (an UI 250) for setting operation statues, interpretation of print information, and the like. The RAM 110 is used for various applications. The RAM 110 according to this embodiment is constituted by the following elements for main applications. The RAM 110 includes a reception buffer 111, a work area 112 necessary for the operation of a program, a high-resolution rendering area 113, printing mechanism control information 114, an execution program expansion area 115, and rendering multilevel information 116.

The reception buffer 111 is an area for temporarily storing print information. The high-resolution rendering area 113 uses an expansion area in which a high-resolution rendering image is expanded. The execution program expansion area 115 is used to expand an execution program at the time of execution of the program. Note that the execution program expansion area 115 may not be required or be secured as an area having a large size depending on the arrangement. If, for example, a large area is secured as the ROM 120, the execution program expansion area 115 may not be required. In contrast to this, if the ROM 120 has a small capacity and only a function of loading a necessary execution program into the execution program expansion area 115, an area with a large size must be secured as the execution program expansion area 115. The rendering multilevel information 116 is a storage area for rendering multilevel signals.

In the nonvolatile memory 130, various kinds of setting information 150 and a data save area 154 are secured. The various kinds of setting information 150 are a group of information which includes dynamic information about the mechanical units of the printing mechanism and consumable items and needs to be held even at the time of power interruption.

The ROM 120 contains a printing mechanism control program 151, a resolution conversion program 152, and a UI control program 153. The printing mechanism control program 151 is used to operate the printing mechanism. The resolution conversion program 152 interprets print information and converts it into control information capable of printout. The UI control program 153 controls the UI 250.

Depending on the arrangement, it is possible to store the above program in the nonvolatile memory 130 instead of the ROM 120 and make the ROM 120 to have a relatively small capacity to store only a program for expanding the above program in the execution program expansion area 115 in the RAM 110.

The printing apparatus is sometimes required to perform sleep operation for power saving operation. When performing this sleep operation, the apparatus uses the data save area 154. The data save area 154 stores setting information necessary for quick return to operation or an initialization state, which may be lost at the time of complete interruption of power.

The input/output mechanism 140 includes an operation panel I/F 141, an external device I/F 142, and an internal mechanism I/F 143. The operation panel I/F 141 receives settings for devices and the like and outputs and displays a status in the printing mechanism to present it to the operator. The external device I/F 142 is an interface with an external device 270. The external device I/F 142 externally receives image information in a predetermined format and outputs status information in the printing mechanism to the outside. The external device 270 may implement a function corresponding to the operation panel I/F 141 by software implementation.

The internal mechanism I/F 143 is an interface with each unit of the printing mechanism. The internal mechanism I/F includes control inputs/outputs for a motors, clutches, sensors, and the like constituting the mechanical units of the printing mechanism and internal I/O formed by a rendering unit based on image information. The electrophotographic printing apparatus performs control to operate various kinds of mechanisms at predetermined timings and shift their operation states to steady states.

The CPU 100 needs to stabilize the rotation of a polygon mirror 204 and send and render an image in accordance with the timing of optical scanning before transferring a toner image on a photosensitive member 208 onto a sheet, and hence executes corresponding control operations, in accordance with various kinds of programs.

The printing apparatus further operates the charging mechanism at a proper timing before and after optical rendering, and executes developing. While the fixing device with large power consumption is paused at the time of non-execution of printing operation, it is necessary to raise a temperature to a predetermined temperature and stable it before a sheet 300 reaches the fixing device. The internal mechanism I/F 143 executes checking and output control on sensor information necessary for the execution of these operations.

As described in the first embodiment with reference to FIG. 2, the mechanical unit 200 is a mechanism unit of another printing mechanism. The UI 250 is an operation panel. The user operates the UI 250 to designate whether to select a high-quality mode as a printing mode. The external device I/F 142 is connected to the external device 270. The input/output mechanism 140 is used to perform rendering information from the external device 270 or designate an operation mode. The schematic view of the arrangement of the mechanical unit 200 is the same as that described in the first embodiment with reference to FIG. 2.

[Processing Procedure]

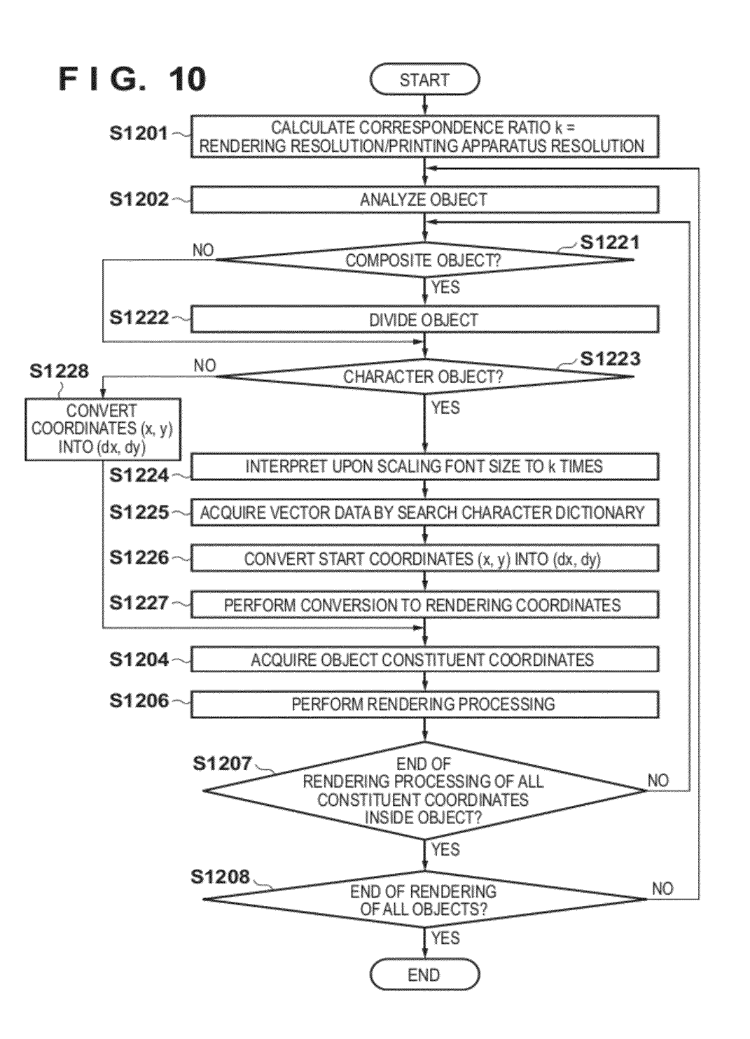

FIG. 10 shows a flowchart showing a procedure for coordinate correction processing by the printing mechanism unit of the image processing apparatus according to this embodiment. This processing corresponds to that described in the first embodiment with reference to FIG. 7. In addition, a procedure for rendering processing is the same as that described in the first embodiment with reference to FIG. 6.

In this embodiment, when starting the processing in the processing procedure shown in FIG. 6, the printing mechanism externally receives data (S1100). In general, the print request sent from the external device 270 is an image to which accessory information such as a size, color, and resolution is attached in a specific format or a designation for rendering objects formed by a page description language, or is set in a composite format thereof. In this embodiment, the coordinate system of the rendering data sent from the external device 270 is the actual coordinate system (x, y). That is, the resolution (first resolution) of received data is equal to that of the printing mechanism.

Note that the printing apparatus includes an interpreter for a page description language or image format to analyze received data and cope with a complicated rendering request. In addition, the printing apparatus expands an execution program serving as a processing unit corresponding to print data in the execution program expansion area 115, and processes the data buffered in the reception buffer 111.

The apparatus then performs coordinate correction processing for the rendering object (S1200). In this case, to improve the print quality by executing rendering with a resolution higher than that of the printing mechanism, first of all, the CPU 100 executes rendering with a high resolution (second resolution) in the high-resolution rendering area 113. At this time, the apparatus performs rendering in consideration of a phase with the resolution of the printing mechanism. This processing will be described in detail with reference to FIG. 10.

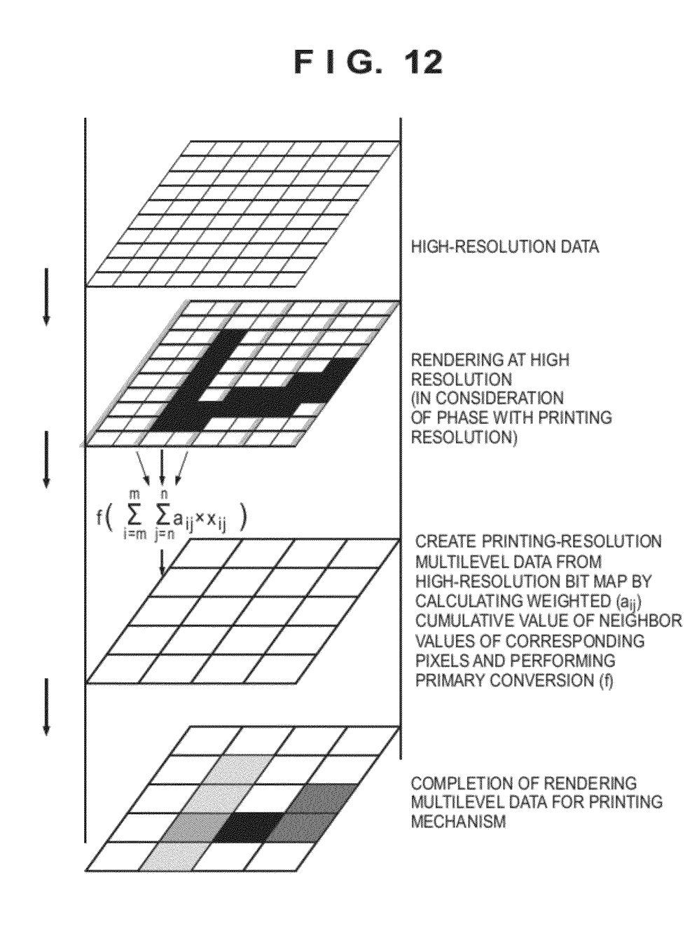

The CPU 100 converts the data rendered on the high-resolution rendering area 113 by the resolution conversion program 152 at a high resolution into printing-resolution multilevel data (data in the actual coordinate system) of the rendering multilevel information 116 (S1300). The conversion processing in this case is not simple thinning, and is performed by assigning predetermined weights to a plurality of neighbor high-resolution rendering data to calculate a cumulative value, as shown in FIG. 12. In addition, to correct the nonlinearity of an electrophotographic characteristic, the apparatus calculates multilevel density information after primary conversion. Weight values and primary conversion values are adjusted in accordance with the electrophotographic characteristic of the printing mechanism.

Upon completion of conversion to printing-resolution data, the CPU 100 executes printout by causing the respective mechanical units via the internal mechanism I/F 143 to operate at predetermined timings, based on the printing-resolution data (S1400).

Processing corresponding to step S1200 will be described with reference to FIG. 10. When starting the processing, the CPU 100 acquires the correspondence ratio (magnification k) between the rendering resolution and the resolution of the printing mechanism (S1201). In this embodiment, the correspondence ratio is calculated by the following equation. Assume that a rendering resolution for coordinate correction in this processing is defined in advance.

correspondence ratio=rendering resolution/resolution of printing mechanism

The CPU 100 calculates final rendering coordinates and analyzes a composite object based on rendering information described in the page description language (S1202). The CPU 100 determines whether the analyzed object is a composite object (S1221). If the object is a composite object (YES in step S1221), the CPU 100 divides the composite object analyzed by the interpreter of the image processing apparatus into separate objects (S1222). The CPU 100 determines whether the divided objects are character objects (S1223). If they are character objects, externally received coordinate information includes only start coordinates. It is therefore necessary to search dictionary data defining character information from the character type and character code received as attribute information other than start coordinates and scale the data to the size designated by the font size.

If the object is a character object, the size of the character is designated with a size in the actual coordinate system. For this reason, the CPU 100 scales the character object to k times so as to have a proper size in the high-resolution rendering space and interprets the resultant data (S1224). With this processing, the actual coordinate system of the printing mechanism matches in phase with the high-resolution rendering coordinate system with respect to a plurality of objects included in the rendering data.

The CPU 100 acquires a vector information group corresponding to a character from the respective character objects based on dictionary data defining character information (S1225). The CPU 100 performs coordinate conversion of the start coordinates of the object (S1226). The CPU 100 creates data to be output by coordinate conversion of the remaining rendering coordinate information constituting the character object (S1227). In this case, the CPU 100 scales the vector information group to generate constituent coordinate information constituting the object with reference to the start coordinates.

If the object is not a character (NO in step S1223), the CPU 100 simply converts the constituent coordinates by using the following equations (S1228):

dx=x×k

dy=y×k

The CPU 100 acquires constituent coordinate information of pixels constituting an object (S1204). The CPU 100 arranges pixels based on the constituent coordinate information acquired in step S1204 and executes rendering processing (S1206). The CPU 100 repeats rendering processing for all pieces of coordinate information corresponding to the pixels constituting the object (S1207). Upon completing the processing for all the pixels constituting the object (YES in step S1207), the CPU 100 obtains a new object which has not been processed and repeats the processing (S1208). Upon completing the overall rendering processing (YES in step S1208), the CPU 100 terminates this processing procedure.

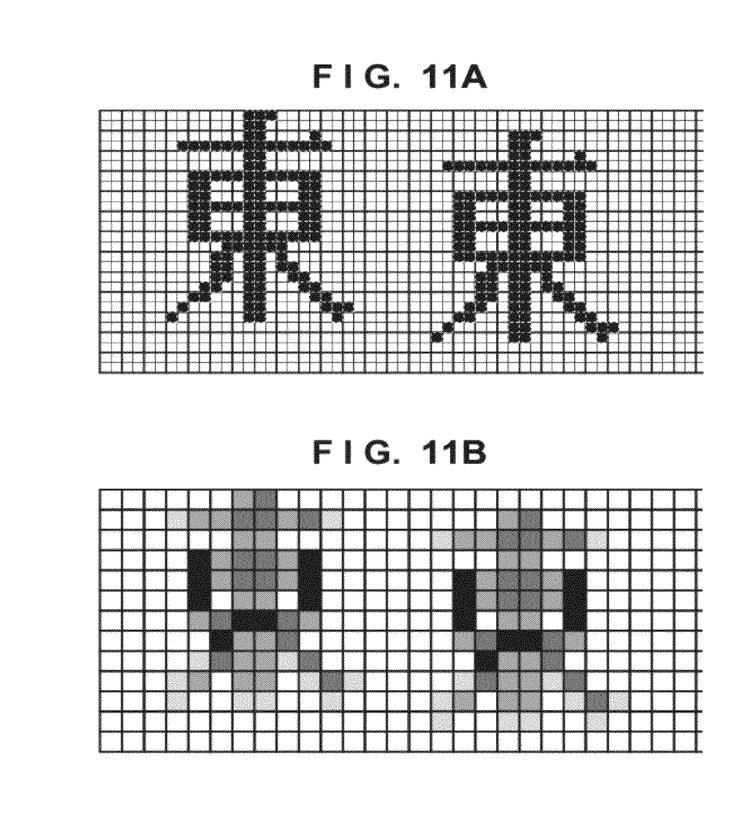

With the above processing, if the resolution of input rendering data is equal to that of the printing mechanism, it is possible to arrange data such that the start coordinates of a character are always in phase with the resolution of the printing mechanism. This makes it possible to easily execute the processing shown in FIGS. 11A and 11B.

Note that it is possible to apply, to the arrangement of the first embodiment, the processing of specifying a character object by using a dictionary defining character information and the processing of dividing a composite object.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-102345, filed Apr. 28, 2011, which is hereby incorporated by reference herein in its entirety.

What is claimed is:

1. An image processing apparatus comprising:
a reception unit configured to receive data with a first resolution;
a correction unit configured to correct a coordinate system of the data with the first resolution into a coordinate system with a second resolution higher than the first resolution;
a rendering unit configured to perform rendering processing for the data with the second resolution which is corrected to the coordinate system with the second resolution by said correction unit; and
a resolution conversion unit configured to convert the data with the second resolution rendered by said rendering unit into the data with the first resolution by performing weighting calculation processing for a pixel in the data with the second resolution and a neighbor pixel of the pixel.

2. The apparatus according to claim 1, wherein the first resolution is a printing resolution.

3. The apparatus according to claim 1, wherein the data with the first resolution after conversion by said resolution conversion unit is multilevel data.

4. The apparatus according to claim 1, wherein when the data with the first resolution received by said reception unit includes a character object, said correction unit corrects start coordinates of the character object into the coordinate system with the second resolution.

5. An image processing method comprising:
a reception step of receiving data with a first resolution;
a correction step of correcting a coordinate system of the data with the first resolution into a coordinate system with a second resolution higher than the first resolution;
a rendering step of performing rendering processing for the data with the second resolution which is corrected to the coordinate system with the second resolution in the correction step; and
a resolution conversion step of converting the data with the second resolution in the rendering step into the data with the first resolution by performing weighting calculation processing for a pixel in the data with the second resolution rendered and a neighbor pixel of the pixel.

6. A computer-readable medium storing a program for causing a computer to function as
a reception unit configured to receive data with a first resolution,
a correction unit configured to correct a coordinate system of the data with the first resolution into a coordinate system with a second resolution higher than the first resolution,
a rendering unit configured to perform rendering processing for the data with the second resolution which is corrected to the coordinate system with the second resolution by the correction unit, and
a resolution conversion unit configured to convert the data with the second resolution rendered by the rendering unit into the data with the first resolution by performing weighting calculation processing for a pixel in the data with the second resolution and a neighbor pixel of the pixel.
